(19) United States
(12) Patent Application Publication
(10) Pub. No.: US 2025/0378513 A1
(43) Pub. Date: Dec. 11, 2025

(54) Athlete and Agent Career Management System

(71) Applicants: Shane Costa, Buffalo, NY (US); Christian Kranz, Buffalo, NY (US)

(72) Inventors: Shane Costa, Buffalo, NY (US); Christian Kranz, Buffalo, NY (US)

(21) Appl. No.: 19/231,628

(22) Filed: Jun. 9, 2025

Related U.S. Application Data
(60) Provisional application No. 63/657,800, filed on Jun. 8, 2024.

(51) Int. Cl. G06Q 50/18; G06Q 30/0201; G06Q 50/20

(52) U.S. Cl. CPC G06Q 50/18; G06Q 30/0206; G06Q 50/2057

(57) ABSTRACT

An athlete career management system and platform and method for utilizing or fabricating such a system or platform. The system for athlete career management and decision support provides a comprehensive software platform designed to facilitate various career-related decisions for athletes. Utilizing proprietary algorithms, artificial intelligence, and advanced data collection techniques, the system offers integrated functionalities that streamline career planning, contract negotiations, professional service recommendations, and educational support.

### CROSS-REFERENCE TO RELATED APPLICATIONS

This application claims priority to U.S. Provisional Patent Application having Ser. No. 63/657,800, filed on Jun. 8, 2024, the entire disclosure of which is hereby incorporated herein by reference.

### BACKGROUND

The professional sports industry, which includes prominent leagues such as the NFL, MLB, and NBA, involves a complex array of contract negotiations, collective bargaining agreements (CBAs), endorsement opportunities, and professional service recommendations. Historically, athletes have depended on agents to manage these multifaceted activities. However, current methods are inefficient and have room for improvement.

Contract negotiations are a significant aspect of athlete career management. Agents traditionally determine a player's market value by manually analyzing league contracts, performance metrics, and market trends. Current platforms lack integrated algorithms and data analytics techniques required to automate market value assessments. This manual approach is time-consuming and prone to human error, extending the negotiation period and potentially leading to less favorable contract terms for athletes.

CBAs are intricate documents that outline the contractual relationships between players and leagues, encompassing salaries, benefits, injury policies, and dispute resolution procedures. Currently, athletes either decipher these documents on their own or depend on agents for interpretation. The interpretation demands proficiency in legal jargon and contract law, presenting a formidable challenge for athletes. Existing platforms fail to offer streamlined modules for comprehending and interpreting these agreements, leading to gaps in understanding and possible misinterpretations.

Athletes frequently seek endorsement and sponsorship opportunities to enhance their income and market presence. Marketing platforms such as INFLCR/Openendorse connect athletes with brands but focus primarily on promoting marketing partnerships, operating independently of other career management tools. As a result, agents and athletes need to navigate multiple disparate systems to manage comprehensive career information, leading to inefficiencies in harnessing commercial opportunities that align with the athlete's brand and strategy.

The management of professional services, such as legal consultation, financial planning, and medical assistance, forms another crucial aspect of an athlete's career. Recommendations for these services often rely on personal networks and ad-hoc consultations. There is an evident lack of a single platform consolidating professional service recommendations tailored specifically to the athletic industry, especially those that cater to personalized needs. Injuries, a common occurrence in athletic careers, require swift and reliable recommendations for qualified doctors. The absence of integration in current systems can delay crucial responses, negatively impacting an athlete's recovery and performance.

Off-season planning, which prepares athletes for the upcoming competitive season through training regimens and rehabilitation programs, alongside education on player benefits such as pensions, health plans, and post-career opportunities, also requires attention. The current landscape is fragmented, with individual solutions addressing segments of planning and education but not offering a holistic approach. Platforms like Teamworks facilitate team communication but do not extend to comprehensive off-season planning or delivering player benefits education tailored to individual athletes' needs.

What is needed is an integrated platform that consolidates various aspects of athlete career management into a cohesive system, employing advanced technologies such as artificial intelligence and propriety algorithms. Such a platform would automate and enhance decision-making processes, streamline contract negotiations, provide precise market value assessments, offer detailed CBA interpretations, and integrate opportunities for commercial endorsements, professional service recommendations, injury management, off-season planning, and player benefits education. This advancement would address the existing inefficiencies and empower both athletes and agents to make more informed and effective decisions, thereby optimizing career outcomes in the professional sports industry.

### FIELD

The present technology relates to software systems and methods for athlete career management and decision support. Specifically, it pertains to platforms leveraging proprietary algorithms, artificial intelligence, and data analytics to assist athletes in areas including contract negotiations, endorsement opportunities, professional services recommendations, collective bargaining agreement interpretation, and career education.

### SUMMARY

In one aspect, the system for athlete career management and decision support provides a comprehensive software platform designed to facilitate various career-related decisions for athletes. Utilizing proprietary algorithms, artificial intelligence, and advanced data collection techniques, the system offers integrated functionalities that streamline career planning, contract negotiations, professional service recommendations, and educational support.

One objective of the invention is to enhance the efficiency of managing an athlete's career by simplifying complex processes such as interpreting collective bargaining agreements (CBAs) and calculating an athlete's market value. By doing so, the system assists athletes and agents in making informed, data-driven decisions.

In another aspect, the system divides its functionalities into interconnected modules, each specializing in different areas of career management. Modules include market value determination, CBA analysis, contract and professional services sorting, data integration and storage, and an AI-driven autopilot module. These modules work in concert to provide a robust, holistic management tool tailored for athletes.

In an embodiment, the market value determination module employs custom-built algorithms to calculate an athlete's market worth by analyzing performance metrics, historical contract data, and market trends. This ensures precise valuation essential for effective contract negotiations.

Yet another objective of the present disclosure is to provide tools for identifying endorsement opportunities and suggesting optimal off-season activities based on historical performance data. The system's advanced analytics help align these opportunities with the athlete's career objectives, thereby maximizing potential earnings.

In another embodiment, the CBA analysis module uses natural language processing (NLP) algorithms to parse and simplify legal jargon found in collective bargaining agreements. This makes complex legal information accessible and understandable for athletes without extensive legal training.

In a further aspect, the platform's architecture is designed to be scalable and adaptable for various sports leagues, including NFL, MLB, NBA, NHL, MLS, and even the NCAA. This adaptability ensures that the system can meet the unique requirements and data structures of different athletic organizations by modifying its algorithms and AI models as needed.

In yet another embodiment, the user-interface is designed to be intuitive and user-friendly, allowing easy access to insights from all modules. This consolidated dashboard enables athletes and agents to make quick, informed decisions.

In an additional object of the patent, the system aims to provide educational tools that ensure athletes are fully aware of the benefits and obligations outlined in their contracts and collective bargaining agreements. By doing so, the platform promotes informed career management and decision-making.

Overall, the integration of various career management tools into a single platform differentiates this system from existing solutions, offering a comprehensive approach to athlete career management. This holistic system not only supports athlete and agent decision-making but also adapts to ongoing changes in the athletic industry, ensuring its continued relevance and utility.

It is noted that while the present disclosure primarily focuses on agent and athlete profiles, the system may also include the profiles of parents, spouses, coaches, executives, reporters, and any other profile that may be useful.

### BRIEF DESCRIPTION OF THE DRAWINGS

FIG. 1 is a block diagram illustrating a cloud-based system architecture comprising components such as a virtual private cloud, internet services, and user-facing applications.

### DETAILED DESCRIPTION

It is noted that the term “contract data” as used herein and in the appended claims includes any data that is relevant to helping inform a player's decision to sign a contract. This data includes, but is not limited to, market value determination, other player's contracts, CBA analysis, et cetera.

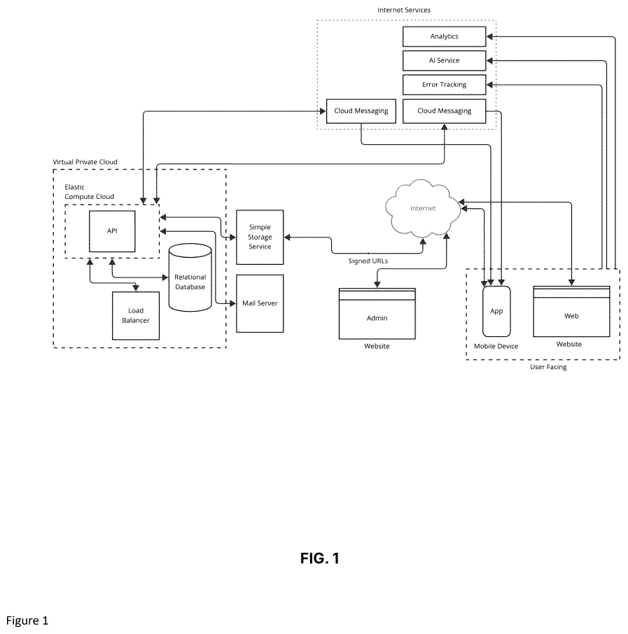

FIG. 1 shows a system architecture comprising multiple interconnected components within a virtual private cloud and user-facing interfaces. The virtual private cloud includes an elastic compute cloud, which houses an API, a relational database, and a load balancer. The API interfaces with the relational database to manage data transactions, while the load balancer distributes incoming network traffic to optimize resource use and prevent overload.

The system further includes a simple storage service connected to the relational database, facilitating data storage and retrieval. A mail server is also integrated, enabling email communications within the system. Signed URLs are generated and utilized by the admin website, allowing secure access to resources stored in the simple storage service.

The architecture extends to internet services, which include analytics, an AI service, error tracking, and cloud messaging components. These services interact with the cloud messaging system to facilitate communication and data exchange across the network. The internet serves as a conduit for these interactions, linking the virtual private cloud to user-facing components.

User-facing elements consist of a mobile device app and a web interface, both of which connect to the internet services and the admin website. This configuration allows users to access and interact with the system through various platforms, ensuring a seamless user experience. The system's design supports scalability and flexibility, accommodating potential variations and enhancements in different embodiments.

The diagram provides an architectural overview of a cloud-based system using multiple cloud services, applications, and devices to deliver athlete management capabilities. The system's integration with a web service provider that provides a virtual private cloud and internet services is detailed, showing data flow and service relationships.

The virtual private cloud block, surrounded by a dashed line labeled “Virtual Private Cloud”, encloses several components:

Elastic Compute Cloud (EC2®)—This component provides computing resources within the Virtual Private Cloud (VPC), used to manage web traffic and applications. Load Balancer (ALB)—Responsible for distributing incoming application traffic across multiple EC2®® instances. Relational Database Service (RDS®)—Storing and managing data, it is connected with the other server or AWS® components to facilitate data operations. API—The API layer of the athlete career management system is implemented using Node.js, serving as the central interface between the React Native mobile application, the web client, and the admin dashboard. This API layer is responsible for handling all authentication processes, business logic, and CRUD (Create, Read, Update, Delete) operations across the platform. It facilitates communication between the user interfaces and the backend infrastructure, ensuring secure and efficient data transactions. The API interacts with the Relational Database to manage structured data related to users, events, notifications, and content. Additionally, the API supports session management and integrates with various services for email delivery, push notifications, analytics, and AI functionality, thereby enabling comprehensive athlete management capabilities.

Adjacent to these, the diagram illustrates the Simple Storage Service (S3®), depicted by a box interfacing directly with the internet to manage storage of data and media files.

Above the Virtual Private Cloud infrastructure, the diagram includes a section for internet services inside a black dashed line, labelled “Internet Services”, comprising:

Analytics—for providing analytics for the system performance. AI Services—Represented as a higher-level service interacting with other internet services. Error Tracking—for providing information about errors in the system. Cloud Messaging (CM)-Integrated for sending messages to user devices.

Data flow arrows indicate that elements within the VPC communicate bi-directionally with these internet services, facilitating broader functionality such as notifications and updates.

To the right, a cloud icon labeled “Internet” connects the VPC and internet services to end-user applications, including:

Admin and Web App-Two sections residing under “Website”, which interact with the storage service through signed URLs. App on a Mobile Device—Utilizes notifications and updates that flow back from internet services.

### Backend Architecture Overview

### API Layer

The backend is built in Node.js, acting as the central interface between the mobile app (preferably React Native), the web client, and the admin dashboard. It handles all authentication, business logic, and CRUD operations across the platform.

### Database

While any database hosted on any server is suitable to support the system of the present disclosure, in a preferred embodiment, a MySQL® database is hosted on AWS® RDS®. The database includes all all structured data related to users, events, notifications, and content flows.

### Infrastructure & Hosting:

In a preferred embodiment, the system is hosted entirely on AWS® The backend runs behind a load balancer inside a VPCThe Frontend assets are served via an EC2® instance Images and media assets are stored in S3®

### Key Integrations

Authentication & Session Management: Handled internally through the APIEmail

Delivery: Managed via SMTP through MailerSendPush Notifications: Delivered using Expo Notifications SDKAnalytics: Implemented through Firebase® for both mobile and web clientsBug Tracking: Integrated with Sentry®AI Functionality: Both mobile and web apps integrate with Dante® AI

Of note, the API is capable of pulling data from the database and to authenticate the session. From there, the API will fetch more data. There is a specific API call depending on the data needed. Some data required may include, but is not limited to, information about the user, team, events, contacts, player contracts.

The system is administered by a third party called Spot Track, which processes information by way of the API. In some embodiments, there is a widget for internet services. There are dual apps for a contract portal and a second app that may be developed later.

The contract portal will have information about NFL players and contract info, and college player information.

As depicted in FIG. 1, there is a web service provider, preferably, Amazon Web Services (AWS®), wherein the web services provider includes a virtual private cloud. A database is included, wherein the database includes data, including contract information, user information, team information, event information, et cetera. In a preferred embodiment, the database is an Amazon Relational Database Service (RDS®). The database is in communication with a cloud service, preferably Amazon Elastic Compute Cloud (EC2®), and a server, preferably Amazon Simple Storage Service (S3®). The cloud service is in communication with an application load balancer (ALB) in order to be able to distribute traffic to multiple backend servers), a mail sender, and the server.

Outside of the web service provider, the cloud service is in communication with a cloud messaging provider, preferably Firebase Cloud Messaging (FCM®), which is in communication with a device. The cloud service is also in communication with a push notification service, preferably, Apple Push Notification Services (APNS®), which is also in communication with a device. The device contains an app for purposes of displaying the information as requested by a user.

An analytics provider, preferably Firebase® Analytics, is in communication with a device and/or a website and provides analytics regarding how the system is performing. An AI service or agent, preferably Dante® AI, is in communication with a device and/or a website and provides chatbots or voice agents to interface with the end user. Finally, an error monitoring program, preferably Sentry®, is also in communication with a device and/or a website.

The web service provider is in communication with the internet, which is also in communication with the device and the website. The internet is also in communication with an admin website. Signed urls, provides the internet limited access to the server.

From an end user viewpoint, in one embodiment, the mobile application interface for an athlete and agent management system may display a greeting message along with a profile picture. There may be a location for text input for user queries. Preferably, there may be a section labeled “Common Player Questions”. In preferred embodiments, the interface contains a navigation bar with five icons: Dashboard, Career, Events, Menu, and an unread notification indicator.

In another interface the screen is organized into eight distinct selectable options, each represented as a rectangular button with a label and an icon indicative of its function. These buttons are:

Contract Help: Positioned on the top left of the options grid, the contract help button displays a dollar sign icon, providing access to tools and resources related to contract negotiations and management. Professional Services: To the right of the contract help button, this button features a briefcase icon and encompasses services that may include legal, financial, and medical assistance tailored for athletes. Injuries: Positioned below the contract help button, this option is marked with a plus symbol and offers resources related to injury management and recovery plans. League Contacts: This option, located to the right of the injuries button, shows an icon resembling an ID badge. It provides access to contacts within the athlete's league, facilitating communication with relevant personnel. Marketing: Found below the professional services button, the marketing button includes a bullhorn icon. It enables athletes to explore endorsement opportunities and marketing strategies. Benefits: To the right of the marketing button, this option features a hand holding a dollar sign, offering resources related to the benefits athletes are entitled to under their contracts and collective bargaining agreements. Off-Season: Located below the injuries button, marked with a calendar icon, this button is geared towards planning off-season activities, including training programs and rest periods. Contact: Positioned to the right of the off-season button, it features an icon of a speech bubble, allowing users to contact a support service or representative within the system for further assistance.

At the bottom of the screen, a navigation bar includes icons for additional functionalities such as Dashboard, Career, Events, and Menu, enabling users to navigate through different sections of the application seamlessly. Each button and navigation icon within the interface is designed to facilitate ease of use and provide direct access to the various support modules within the athlete career management system.

Another interface is designated to assist athletes with career-related guidance. Specifically, the screen is part of the “Career Help” section, which provides essential information and actionable advice about being claimed by a new team.

The top portion of the screen includes a leftward-pointing arrow, which functions as a navigation element allowing the user to return to the previous screen.

The primary content section begins with a header labeled “CAREER HELP” highlighting the primary function of this section. Below this header, a bold and prominently displayed title “Getting Claimed” is featured, which indicates the specific topic under discussion. The subsequent paragraph provides detailed information about the immediate steps and support an athlete will receive upon being claimed by a new team. This includes transportation arrangements, contract continuation details, and relocation assistance such as moving expenses reimbursement and temporary housing accommodations for up to two weeks, subject to confirmation by producing the necessary receipts.

Embedded within the content, three interactive elements offer further resources. The first is a call-to-action link labeled “Review this section of the CBA,” directing users to additional, relevant details within the Collective Bargaining Agreement. The second is a navigation link labeled “More Articles,” allowing users to access additional informational articles on related topics. The third is labeled “Get Contract Advice,” providing access to professional contract negotiation support tools.

The screen reflects the system's design principles, which focus on providing athletes with timely and useful career management information. The navigation bar at the bottom contains five icons, each representing different functionalities within the application: “Dashboard,” “Career,” “Events,” “Menu,” and a search tool, all intended to offer comprehensive navigation across the platform's various modules and services.

Another interface of the athlete career management system on a mobile device includes a section labeled “Featured” highlights an event, which includes event information. This section provides a categorical distinction between different types of events, beneficial for the user's event organization.

At the bottom of the interface, a navigation bar includes labeled icons for various sections of the application: “Dashboard,” “Career,” “Events,” and “Menu.” The “Dashboard” section is highlighted, indicating the current view, while the other icons provide access to different functionalities within the system. This layout facilitates seamless navigation and access to the system's comprehensive career management tools.

In yet another user interface screen from an athlete career management system, which provides critical career-related information in an accessible format. Below the top time display, the screen is divided into two primary sections labeled “Current Contract” and “Market Value.”

In the “Current Contract” section, the player status is indicated by the label “PLAYER STATUS,” which displays “Active” and “VETERAN,” signifying the player's current active status and veteran designation. Adjacent to this, in the “Market Value” section, the next paycheck is quantified by the label “(ESTIMATED),” providing an estimated FIGURE for the athlete's upcoming earnings.

The central part of the UI screen emphasizes critical metrics, including “CREDITED SEASONS” and “ACCRUED SEASONS.” There is a label indicating the number of completed seasons. These metrics are essential for understanding the athlete's eligibility and longevity in their professional career.

Additionally, a statistic for “CREDITED GAMES” is presented with a “0%,” reflecting game credit status. This metric assists in tracking the athlete's participation in regular-season games, impacting the overall credited seasons.

At the bottom of the FIGURE, a navigational menu offers various options including “Dashboard,” “Career,” “Events,” and “Menu,” allowing users to access different sections of the management system swiftly. The active or selected section is marked by a red icon under “Career,” indicating the current view.

This detailed user display integrates critical career data such as contract status, market value, credited and accrued seasons, thereby enabling athletes to make informed decisions regarding their career management and progression.

In a subsequent interface a “Career” section of an athlete career management software platform is included. At the top of the FIGURE, the current contract status of the athlete is displayed prominently, delineated into “SIGNED/FREE AGENT” and the years “in a large blue font, indicating the contract duration. Adjacent to the current contract status, the “Market Value” subsection is also present.

Below the contract status information, an “Annual Base Salary” graph is rendered, presenting a visual breakdown of the athlete's yearly salary over the specified years.

Further down, a “Contract Breakdown” section provides a tabular summary of the athlete's contractual terms. The table contains five columns labeled “YEAR,” “TEAM,” “AGE,” “BASE SALARY,” and “SIGNING BONUS.”

At the bottom of the FIGURE, a navigation bar is displayed with icons labeled

“Dashboard,” “Career,” “Events,” and “Menu.” The “Career” icon is specifically highlighted in red, indicating that the user is currently viewing the Career section.

This comprehensive interface aids athletes and their agents in effectively managing and reviewing contracts, ensuring informed decision-making regarding career progression.

In another interface, a player's market value and current contract details is outlined. The “Market Value” section calculates an average annual salary. It shows “Total Salary,” “Avg. Salary,” “NFL Rank,” and “Player Position Rank”.

The “Current Contract” lists attributes such as “Free Agent” with an average salary. It also presents comparable players based on age, contract status, and production.

An additional interface includes a section labeled “Current Contract” on the left side and “Market Value” on the right side. Under “Current Contract,” the status is indicated with the accompanying average salary specified. Additional metrics such as “NFL RANK” and “POSITION RANK” are present.

Beneath the contract details, the interface includes a section labeled “Comparable Players.” This section contains a subtitle indicating that comparable players have been selected based on parameters such as age, contract status, and statistical production. A table is displayed featuring the headings “PLAYER,” “LENGTH,” “VALUE,” and “AVG. SALARY.” Three players are listed in the table.

The bottom part of the interface includes a navigation menu composed of icons labeled “Dashboard,” “Career,” “Events,” and “Menu.”

In an interface having the athlete career management system's main menu, specifically as it appears on a mobile device. The upper portion of the screen displays various status indicators.

Below the status bar is a header section labeled “Menu,” positioned within a black background that transitions to a white surface using a wavy design. This header serves as the title for the menu list presented below it.

The main body of the screen lists several selectable items, each accompanied by an icon representing the respective category. These items include:

Professional Services: This item is represented by an icon of a headset, indicating access to a directory or resources related to professional services such as legal, financial, or medical support. League Contacts: This item is represented by an icon of a football helmet, suggesting access to contact information for league officials, team representatives, or other related personnel. Common Player Questions: This item features an icon of a head with a gear inside, symbolizing information or a FAQ section addressing common inquiries athletes may have. Marketing: Identified by an icon that resembles a marketing strategy (a broom and sparkles), this item signifies features related to marketing opportunities or strategies for career promotion. Settings: Marked by a gear icon, this section allows users to manage application settings and preferences. Logout: This item features an icon of an arrow pointing toward an opening, indicating the option to log out of the system.

At the bottom of the screen, a navigation bar provides access to other main sections of the application, including: dashboard, career, events, and menu.

There is a “Professional Services” section of a user interface within an athlete career management system that includes several labeled components, such as a search bar and category tabs, which organize the professional services into different types, including “ALL,” “DOCTOR,” “DENTIST,” “ACCOUNTANT,” and “LAWYER.” This feature aids athletes in quickly sorting through various professional service categories relevant to their needs.

A header titled “Professional Services” with an associated “Map” feature positioned on the upper right gives users an option to switch between list and map views of the services.

The display lists contact information for professionals categorized under the each group. Each entry provides the professional's name, the associated establishment, and the location.

A bottom navigation bar offers quick access to different sections of the platform, including “Dashboard,” “Career,” “Events,” and “Menu”.

The described user interface component effectively supports an athlete's selection and management of essential professional services by providing organized, easily accessible, and detailed listings tailored to their specific team affiliation. This allows athletes to make informed decisions regarding their professional needs efficiently.

Another interface primarily includes a title bar at the top, denoting the current page title “Marketing” with a navigation option to return to a previous screen.

Below the title bar, three distinct help topics are presented, each within their respective sections:

Shipping A Car-Displayed as the first topic under the “MARKETING HELP” category, this section includes a truncated description indicating it provides advice on car shipping, potentially critical for users experiencing different scenarios with their team. Finding An Apartment—Listed as the second topic, also under the “MARKETING HELP” category, this section advises individuals like early round picks or veterans on securing apartment accommodations. Renting Furniture—The third topic, under the same “MARKETING HELP” category, offers guidance on furniture rental, especially beneficial for users without pre-furnished apartments.

The interface also includes a bottom navigation bar with four icons labeled as “Dashboard,” “Career,” “Events,” and “Menu.” These icons provide quick access to different sections of the application. Given the context, the “Shipping A Car,” “Finding An Apartment,” and “Renting Furniture” options indicate specific areas where users can receive targeted assistance related to various aspects of marketing help.

For illustrative purposes there may be a profile for a player. It is understood that profiles may also be made for a coach, an executive, a scout, and an agent and still fall within the scope and spirit of the present disclosure.

This integration enables real-time management, data storage, and communication between various user interfaces and cloud infrastructure, ensuring comprehensive athlete management capabilities throughout the system.

It will be appreciated by those skilled in the art that while the athlete career and agent management system has been described in detail herein, the invention is not necessarily so limited and other examples, embodiments, uses, modifications, and departures from the embodiments, examples, uses, and modifications may be made without departing from the process and all such embodiments are intended to be within the scope and spirit of the appended claims.

1. A system for athlete career management, comprising:
a. a virtual private cloud configured to host a plurality of interconnected components, including an elastic compute cloud, a relational database, and a load balancer;
b. an API layer implemented using Node.js, configured to handle authentication, business logic, and CRUD operations, interfacing with a mobile application and a web client;
c. a simple storage service for data storage and retrieval;
d. internet services comprising analytics, AI services, error tracking, and cloud messaging components;
e. user-facing interfaces including a mobile device app and a web interface, configured to provide access to career management functionalities;
f. modules for market value determination, CBA analysis, contract management, professional services recommendations, and educational support.

2. The system of claim 1, wherein the market value determination module employs custom-built algorithms to analyze performance metrics, historical contract data, and market trends.

3. The system of claim 1, wherein the CBA analysis module utilizes natural language processing algorithms to parse and simplify legal jargon in collective bargaining agreements.

4. The system of claim 1, further comprising a contract portal configured to provide information about NFL players, contract details, and college player information.

5. The system of claim 1, wherein the user interface is designed to be intuitive and user-friendly, comprising a navigation bar with icons for Dashboard, Career, Events, and Menu.

6. The system of claim 1, wherein the professional services module includes a search bar and category tabs for organizing services into types such as doctor, dentist, accountant, and lawyer.

7. The system of claim 1, wherein the AI services component integrates with Dante® AI to provide chatbots or voice agents for user interaction.

8. The system of claim 1, wherein the analytics component is implemented through Firebase® Analytics to monitor system performance.

9. The system of claim 1, further comprising a push notification service configured to deliver notifications to user devices.

10. The system of claim 1, wherein the API layer supports session management and integrates with services for email delivery, push notifications, analytics, and AI functionality.

11. A computer-generated method for athlete career management comprising:
a. receiving, by a database, contract information that includes contract data;
b. responsive to receiving a request, from a signed URL, a server initiates fetch logic to request a contract dataset, from a contract API;
c. responsive to receiving a request from the contract API, the database generates the contract dataset;
d. receiving the contract dataset from the database, by the contract API;
e. responsive to receiving the contract dataset from the contract API, by the server, the server initiates compilation logic to compile the contract dataset into a compiled contract dataset; and,
f. responsive to receiving the compiled contract dataset, contract API, generates a display of the compiled contract dataset to be sent by a cloud messenger to a mobile device display or a display.

12. The method of claim 11, wherein the step of compiling the contract dataset into a compiled contract dataset may be iterative and may be performed at least two times.

13. The method of claim 12, wherein a machine learning platform is also utilized by the server.

14. A computer-implemented method for managing athlete career data, comprising:
a. receiving, by a relational database, athlete-related data including performance metrics, contract details, and market trends;
b. responsive to a request from a signed URL, initiating a fetch operation by a server to retrieve athlete data from an athlete data API;
c. responsive to receiving a request from the athlete data API, generating an athlete data set by the relational database;
d. receiving the athlete data set from the relational database, by the athlete data API;
e. responsive to receiving the athlete data set from the athlete data API, initiating a processing operation by the server to process the athlete data set into a processed athlete data set; and
f. responsive to receiving the processed athlete data set, generating a display of the processed athlete data set by the athlete data API to be transmitted via a cloud messaging service to a mobile device display or a web interface.

15. The method of claim 14, wherein the athlete-related data further includes historical performance data and endorsement opportunities.

16. The method of claim 14, wherein the processing operation by the server includes applying machine learning algorithms to analyze the athlete data set for predictive insights.

17. The method of claim 14, wherein the display of the processed athlete data set includes visualizations of performance trends and contract comparisons.

18. The method of claim 14, wherein the cloud messaging service is configured to deliver real-time updates to the mobile device display or web interface.

19. The method of claim 14, wherein the athlete data API is configured to interface with external data sources to enhance the athlete data set with additional market analysis.

20. The method of claim 14, wherein the processed athlete data set includes recommendations for career development based on analyzed market trends and performance metrics.
